(19) United States
(12) Patent Application Publication
(10) Pub. No.: US 2020/0310190 A1
(43) Pub. Date: Oct. 1, 2020

(54) DISPLAY, TERMINAL AND METHOD FOR MANUFACTURING SAME

(71) Applicant: BEIJING XIAOMI MOBILE SOFTWARE CO., LTD., Beijing (CN)

(72) Inventors: Jianglin GU, Beijing (CN); Chiafu YEN, Beijing (CN)

(73) Assignee: BEIJING XIAOMI MOBILE SOFTWARE CO., LTD., Beijing (CN)

(21) Appl. No.: 16/669,787

(22) Filed: Oct. 31, 2019

(30) Foreign Application Priority Data
Mar. 29, 2019 (CN) 201910252262.X

(51) Int. Cl. G02F 1/1333; G02F 1/1362

(52) U.S. Cl. CPC G02F 1/133308; G02F 1/136227; G02F 2001/133317; G02F 1/133305; G02F 1/136286

(57) ABSTRACT

Provided are a display, a terminal, and a method for manufacturing the same. The display includes: a backlight module and a substrate layer, a liquid crystal display layer, and a driving component. The substrate layer, the liquid crystal display layer, and the driving component are disposed above the backlight module. At least one conductive via hole is disposed in the substrate layer, and the conductive via hole is provided with a conductive material, and the conductive material forms a signal path for the driving component.

### CROSS-REFERENCE TO RELATED APPLICATION

This application claims priority to Chinese Patent Application 201910252262.X, filed Mar. 29, 2019, the entire contents of which are incorporated herein by reference.

### TECHNICAL FIELD

The present disclosure pertains to the technical field of electronic devices, and relates to a display, a terminal, and manufacturing methods thereof.

### BACKGROUND

An electronic product, such as a mobile phone or a tablet, is provided with a display screen as an external input device.

Current electronic products pursue a high screen-to-body ratio, so as to reduce the distance between the device frame and the display screen. However, a driving integrated circuit (IC) needs to be disposed at an edge of the display screen, such that the driving IC occupies the space between the display screen and the device frame. This causes a problem whereby it is difficult to reduce the edge distance (the border) between the device frame and the display screen.

### SUMMARY

The present disclosure provides a display, a terminal, and manufacturing methods thereof.

According to one aspect of the present disclosure, there is provided a display comprising a backlight module, a substrate layer, a liquid crystal display layer and a driving component, wherein the substrate layer, the liquid crystal display layer and the driving component are disposed above the backlight module. At least one conductive via hole is disposed in the substrate layer. The conductive via hole is provided with a conductive material, and the conductive material forms a signal path for the driving component.

According to another aspect of the present disclosure, there is provided a terminal comprising: a control unit, a middle frame, and a display disposed at a front side of the middle frame. The display comprises a backlight module, a substrate layer, a liquid crystal display layer and a driving component, wherein the substrate layer, the liquid crystal display layer and the driving component are disposed above the backlight module. At least one set of conductive via holes is disposed in the substrate layer. The conductive via hole is provided with a conductive material, and the conductive material forms a signal path for the driving component.

According to yet another aspect of the present disclosure, there is provided a method for manufacturing a display, the method comprising: determining a calibrated position of a conductive via hole on a substrate layer; forming the conductive via hole by performing a micro via hole processing procedure on the substrate layer using the calibrated position; providing a conductive material within the conductive via hole; leading out the conductive material using a wiring; attaching the driving component to a surface of the substrate layer and electrically connecting a pin of the driving component to the conductive material through the wiring; and mounting a backlight module onto a lower surface of the substrate layer.

It is to be understood that both the foregoing general description and the following detailed description are exemplary and illustrative only and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic cross-sectional view of a screen component of an electronic device in the related art;

FIG. 2 is a side cross-sectional view of the display according to an exemplary embodiment;

FIG. 3 is a side cross-sectional view of the display according to another exemplary embodiment;

FIG. 4 is a flow chart showing the manufacturing of the display according to an exemplary embodiment;

FIG. 5 is a schematic view of a manufacturing process of the display according to an exemplary embodiment; and

FIG. 6 is a schematic structural view of a terminal according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the disclosure as recited in the appended claims.

The present disclosure provides a display which solves a problem in the related art. Specifically, since a driving integrated circuit (IC) needs to be disposed at an edge of the display screen, such that the driving IC occupies the space between the display screen and the device frame, it is difficult to reduce the edge distance (the border) between the device frame and the display screen.

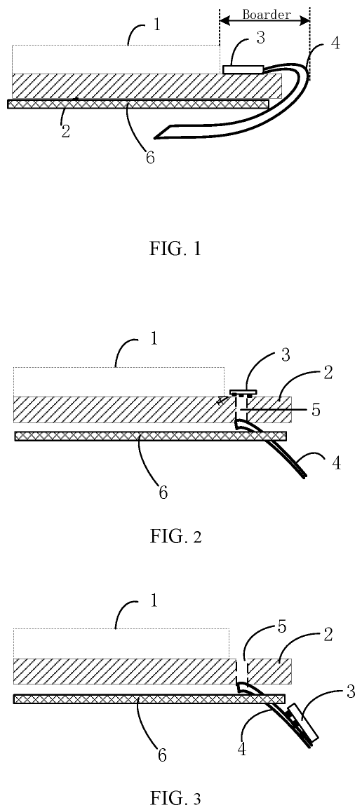

FIG. 1 is a side cross-sectional view of a display of an electronic device in the related art. The screen component is a liquid crystal display (LCD).

The LCD display screen includes a substrate layer 2 which is made of insulating material. The insulating material may be glass or other transparent insulating material. A pixel circuit is disposed on the substrate layer 2. The pixel circuit includes a gate electrode, a gate insulator and a semiconductor layer. The gate insulator is configured to insulate the semiconductor layer and the gate electrode from each other. A source electrode and a drain electrode are further disposed on the base substrate.

An upper surface of the substrate layer 2 is provided with a liquid crystal display layer 1. A driving chip 3 disposed side by side with the liquid crystal display layer 1. An output pin of the driving chip 3 is connected to an input end of the pixel circuit for controlling the brightness of each of the pixels in the pixel circuit so as to control the display state of the liquid crystal display layer 1.

A backlight module 6 is disposed under the substrate layer 2 for providing a light source for the liquid crystal display layer 1.

An input pin of the driving chip 3 is connected to a flexible circuit board 4. The flexible circuit board 4 is connected to a circuit board at a terminal, and is arranged to go around from the edge of the substrate layer 2 to the lower surface of the substrate layer 2. The flexible circuit board 4 is configured for receiving a control signal from the terminal.

In the related art, since a driving chip needs to be mounted at an edge of the liquid crystal display layer 1, such that the driving chip 3 occupies the space between the liquid crystal display layer 1 and the device frame, and since the flexible circuit board 4 connected to the driving chip 3 needs to be arranged to go around from the edge of the substrate layer 2 to the lower surface of the substrate layer, this causes a problem. Specifically, the edge distance (commonly referred to as the border) between the liquid crystal display layer and the edge of the substrate layer is further increased.

FIG. 2 is a side cross-sectional view of the display according to an exemplary embodiment. The display includes a backlight module 6, a substrate layer 2, a liquid crystal display layer 1, and a driving chip 3. The substrate layer 2, the liquid crystal display layer 1, and the driving chip 3 are disposed above the backlight module 6.

At least one conductive via hole 5 is disposed in the substrate layer 2. Illustratively, the at least one conductive via hole 5 comprises a plurality of conductive via holes having a high density and being disposed on the substrate layer 2. The number of conductive via holes that are provided may be dependent upon the number of connection lines between the liquid crystal display layer 1 and the driving chip 3. The conductive via hole 5 is provided with a conductive material, and the conductive material forms a signal path for the driving chip 3.

Alternatively, a set of driving components are respectively disposed on the upper surface and the lower surface of the substrate layer 2, and the signal paths between the driving components are realized by the conductive material in the conductive via hole 5. Or, the driving component is disposed on the lower surface of the substrate layer 2, and a signal path is formed by the conductive material in the conductive via hole 5 and the liquid crystal display layer 1 above the substrate layer 2.

Alternatively, the conductive via hole 5 has a diameter of 5 um to 30 um.

In summary, with respect to the display according to this embodiment, a conductive via hole 5 is disposed on the substrate layer 2 of the display screen, and the conductive via hole 5 is provided with a conductive material. The conductive material is used as a signal path, which saves the space occupied by the circuitry to pass through from the side of the display screen. Moreover, the conductive material reduces the distance between the display screen and the device frame, and increases the screen-to-body ratio of the electronic device.

With continued reference to FIG. 2, the driving component includes at least a driving chip 3 and a flexible circuit board 4. The signal path is a path between the driving chip 3 and the flexible circuit board 4.

Alternatively, the liquid crystal display layer 1 includes a pixel circuit. An input pin of the pixel circuit is connected to an output pin of the driving chip 3, and an input pin of the driving chip 3 is electrically connected to the conductive material in the conductive via hole 5. In an alternative embodiment, the pixel circuit is a Thin Film Transistor (TFT).

The flexible circuit board 4 is disposed on the lower surface of the substrate layer 2. One end of the flexible circuit board 4 is electrically connected to the driving chip 3 disposed on the upper surface of the substrate layer 2 through the conductive material in the conductive via hole 5, and the other end of the flexible circuit board 4 is connected to a control unit in an electronic device. A control unit sends a command signal to the driving chip 3 through the flexible circuit board 4 and the conductive material. The driving chip 3 sends a driving signal to the pixel circuit according to the received command signal for controlling the display state of the liquid crystal display layer 1.

Alternatively, an opening is disposed on the backlight module 6, and the size of the opening is configured to accommodate the flexible circuit board 4. The flexible circuit board 4 passes through the backlight module 6 through the opening. Since the flexible circuit board 4 is thin, the impact thereof on the backlight module 6 is negligible.

In summary, with respect to the display according to this embodiment, the driving chip 3 and the flexible circuit board 4 in the driving component are disposed on the upper surface and the lower surface of the substrate layer 2, respectively. The electrical connection is achieved by the conductive via hole 5 having a conductive capability, which saves the space occupied by the flexible circuit board 4 in traversing the distance from the edge of the substrate layer 2 to the lower side of the substrate layer 2, and helps to reduce the distance between the liquid crystal display layer 1 and the device frame.

Based on the embodiment of FIG. 2, FIG. 3 shows a side cross-sectional view of the display according to another exemplary embodiment of the present disclosure. The driving component includes at least a driving chip 3 and a flexible circuit board 4. The signal path is a path between the liquid crystal display layer 1 and the flexible circuit board 4.

Alternatively, the liquid crystal display layer 1 includes a pixel circuit. An input pin of the pixel circuit is electrically connected to the conductive material within the conductive via hole 5. In an alternative embodiment, the pixel circuit is a Thin Film Transistor (TFT).

A first end of the flexible circuit board 4 is disposed on a lower surface of the substrate layer 2. An output pin of the flexible circuit board 4 is connected to an input pin of the pixel circuit on the upper surface of the substrate layer 2 through the conductive material in the conductive via hole 5. A second end of the flexible circuit board 4 is connected to an output pin of the driving chip 3, and an input pin of the driving chip 3 is connected to a control unit in the electronic device. The control unit sends a command signal to the driving chip 3. The driving chip 3 sends a driving signal to the pixel circuit in the liquid crystal display layer 1 through the flexible circuit board 4 and the conductive material for controlling the display state of the liquid crystal display layer 1.

Alternatively, an opening is disposed on the backlight module 6, and the size of the opening is configured to accommodate the flexible circuit board 4. The driving chip 3 is disposed on the flexible circuit board 4, and the driving chip 3 is disposed outside the backlight module 6. The flexible circuit board 4 connects the driving chip 3 to the conductive material in the conductive via hole 5 through the opening.

In summary, with respect to this embodiment, the flexible circuit board 4 is disposed under the substrate layer 2, which effectively avoids the problem that the flexible circuit board occupies space in the case of passing through from the side of the substrate layer 2. Moreover, the driving chip 3 is disposed outside the backlight module 6, which avoids the problem that the driving chip 3 interferes with the backlight module 6.

The present disclosure provides a terminal including: a control unit, a middle frame, and a display disposed at a front side of the middle frame. The display is configured in accordance with any of the foregoing embodiments.

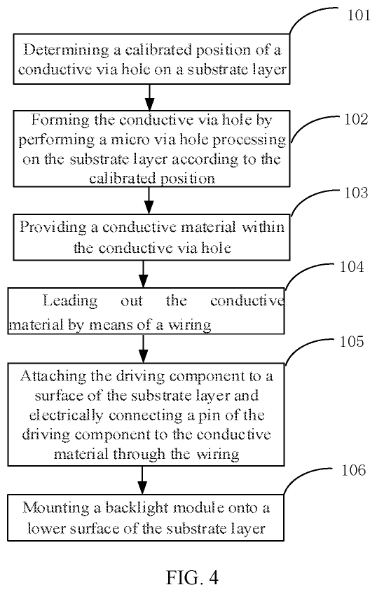

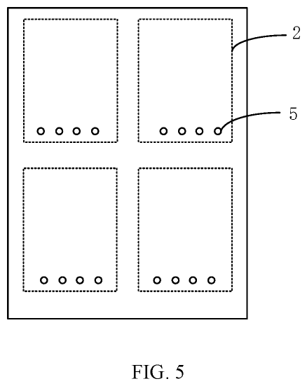

The present disclosure provides a method for manufacturing the display according to any of the foregoing embodiments. Referring to FIGS. 2-5, the substrate layer 2 (FIGS. 2 and 3) is for example a glass substrate, and the manufacturing method includes step 101, step 102, step 103, step 104, step 105, and step 106 (FIG. 4).

In step 101 (FIG. 4), a calibrated position of the at least one conductive via hole 5 (FIGS. 2, 3 and 5) is determined on the substrate layer 2.

The position of the at least one conductive via hole 5 is calibrated on the glass by means of lighting and positioning for the mask, in accordance with the total number of conductive via holes to be provided. The position of each of the conductive via holes to be provided is used to prepare for a subsequent punching operation.

In step 102 (FIG. 4), a micro via hole processing procedure is performed on the substrate layer 2 (FIGS. 2, 3 and 5) according to the calibrated position determined in step 101 to form the conductive via hole 5.

A high-density punching operation is performed on a designated area of the glass according to the calibrated position that was determined in step 101.

Alternatively, a high-density micro via hole processing procedure is performed on the glass by means of lasering, and the via hole5 (FIGS. 2, 3 and 5) has a diameter of 5 um to 30 um.

In step 103 (FIG. 4), the conductive via hole 5 (FIGS. 2, 3 and 5) is provided with a conductive material.

Alternatively, the conductive via hole 5 is at least partially filled with a conductive material such as silver paste, copper paste; or a conductive material is deposited within the conductive via hole using the lighting processing, so that electrical conductivity is provided between the upper surface and the lower surface of the via hole.

In step 104 (FIG. 4), the conductive material is leaded out by means of a wiring.

During thinning of the substrate layer 2 (FIGS. 2, 3 and 5), the conductive material in the conductive via hole 5 is leaded out by means of a through glass via (TGV) wiring. The position at which the conductive material is leaded out is dependent upon the position at which the driving chip 3 is to be disposed.

In step 105 (FIG. 4), the driving component is attached to a surface of the substrate layer 2 (FIGS. 2, 3 and 5) so as to electrically connect a pin of the driving component to the conductive material through the wiring.

Alternatively, the driving component includes a driving chip 3 (FIGS. 2 and 3) bonded on the upper surface of the substrate layer 2 and a flexible circuit board bonded on the lower surface of the substrate layer 2.

In an alternative embodiment, the driving chip 3 is attached to the upper surface of the substrate layer 2, and is connected to the conductive material through the wiring. The flexible circuit board 4 is attached to the lower surface of the substrate layer 2, and is connected to the conductive material through the wiring. The connection relationship is the same as that of the embodiment of FIG. 2, and is not described herein again.

In an alternative embodiment, the flexible circuit board 4 is attached to the lower surface of the substrate layer, and is connected to the conductive material through the wiring. The connection relationship is the same as that of the embodiment of FIG. 3, and is not described herein again.

In step 106 (FIG. 4), a backlight module 6 (FIGS. 2 and 3) is mounted onto a lower surface of the substrate layer 2.

An opening is reserved on the backlight module 6 for connecting the flexible circuit board 4 to a component of an external electronic device through the opening.

In summary, with respect to this embodiment, a conductive via hole 5 (FIGS. 2, 3, and 5) is previously disposed on the substrate layer 2, and a conductive material is poured into the via hole 5 to achieve a TGV hole of the substrate layer 2. The via hole 5 is provided with the conductive material to realize the signal path being provided between the upper surface and the lower surface of the substrate layer 2, which reduces the border distance and improves the screen-to-body ratio of the electronic device.

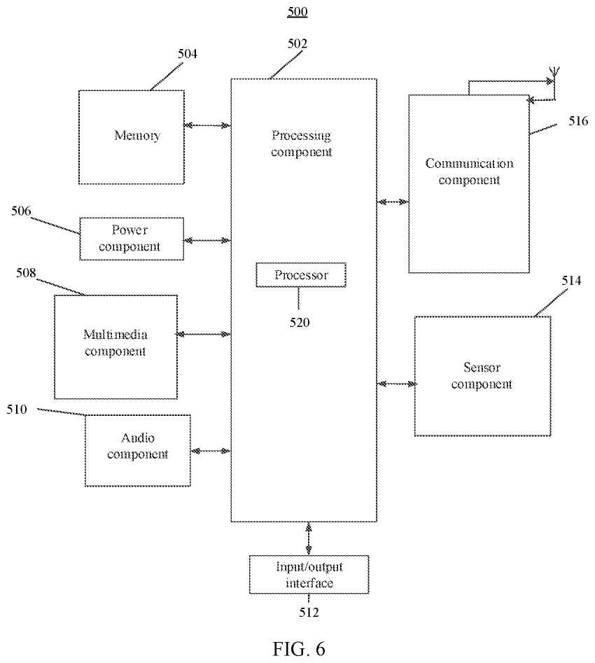

FIG. 6 is a block diagram of a terminal 500 configured in accordance with an exemplary embodiment. For example, the terminal 500 may be a mobile terminal, a tablet computer, a personal computer, a portable electronic device, a display device, or the like.

Referring to FIG. 6, the terminal 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls the overall operations of the terminal 500, such as operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the terminal 500. Examples of such data include instructions for any applications or methods operated on the terminal 500, contact data, phonebook data, messages, pictures, videos, etc. The memory 504 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the terminal 500. The power component 506 may include a power management system, one or more power sources, and any other components associated with the generation, management, and distribution of power in the terminal 500.

The multimedia component 508 includes a screen providing an output interface between the terminal 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense the duration and pressure associated with the touch or swipe action. In some embodiments, the multimedia component 508 includes a front camera and/or a rear camera. The front camera and the rear camera may receive external multimedia data while the terminal 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (MIC) configured to receive external audio signals when the terminal 500 is in an operational mode, such as a call mode, a recording mode, or a voice recognition mode. The received audio signal may be further stored in the memory 504 or transmitted via the communication component 516. In some embodiments, the audio component 510 further includes a speaker for outputting audio signals.

The I/O interface 512 provides an interface between the processing component 502 and peripheral interface modules, such as a keyboard, a click wheel, buttons, or the like. The buttons may include, but are not limited to, a home button, a volume button, a start button, and a lock button.

The sensor component 514 includes one or more sensors to provide status assessments of various aspects of the terminal 500. For instance, the sensor component 514 may detect an on/off status of the terminal 500, relative positioning of components, e.g., the display device and the mini keyboard of the terminal 500. The sensor component 514 may also detect a position change of the terminal 500 or a component of the terminal 500, presence or absence of user contact with the terminal 500, orientation or acceleration/deceleration of the terminal 500, and temperature change of the terminal 500. The sensor component 514 may include a proximity sensor configured to detect the presence of nearby objects without any physical contact. The sensor component 514 may also include a light sensor, such as a CMOS or CCD image sensor, used for imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the terminal 500 and other devices. The terminal 500 can access a wireless network based on a communication standard, such as WiFi, WiMAX, 2G, or 3G, 4G, 5G, Bluetooth, or a combination thereof. In an exemplary embodiment, the communication component 516 receives broadcast signals or broadcast associated information from an external broadcast management system via a broadcast channel.

In exemplary embodiments, the terminal 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing any of the previously-described methods.

In an exemplary embodiment, there is also provided a non-transitory computer readable storage medium including instructions, such as the memory 504 including instructions executable by the processor 520 of the terminal 500 to perform any of the previously-described methods. For example, the non-transitory computer readable storage medium may be a ROM, a random access memory (RAM), a CD-ROM, a magnetic tape, a floppy disk, and an optical data storage device, and the like.

Optionally, the driving component comprises a flexible circuit board and a driving chip. A signal path is provided between the driving chip and the flexible circuit board. Alternatively or additionally, asignal path is provided between the liquid crystal display layer and the flexible circuit board.

Optionally, the driving chip is disposed on an upper surface of the substrate layer, and the flexible circuit board is disposed on a lower surface of the substrate layer. An output pin of the driving chip is connected to an input end of the liquid crystal display layer, and an input pin of the driving chip is connected to an output end of the flexible circuit board through the conductive material.

Optionally, the flexible circuit board is disposed on the lower surface of the substrate layer, and the output end of the flexible circuit board is connected to the input end of the liquid crystal display layer through the conductive material, and an input end of the flexible circuit board is connected to the output pin of the driving chip. Optionally, the conductive via hole has a diameter of 5 um to 30 um.

Optionally, the performing of the micro via hole processing on the substrate layer comprises: performing the micro via hole processing on the substrate layer by any of lasering, ultrasonic drilling, dry etching, and wet etching to form the conductive via hole, wherein the conductive via hole has a diameter of 5 um to 30 um.

Optionally, the providing of the conductive material within the conductive via hole comprises: filing the conductive via hole with silver paste; or, depositing a conductive material within the conductive via hole by using a lighting processing.

Optionally, the driving component comprises a driving chip and a flexible circuit board. The attaching of the driving component to the surface of the substrate layer and electrically connecting the pin of the driving component to the conductive material through the wiring comprises: attaching the driving chip to an upper surface of the substrate layer, attaching the flexible circuit board to a lower surface of the substrate layer, and electrically connecting the driving chip and the flexible circuit board to the conductive material through the wiring, respectively; or, attaching the flexible circuit board to the lower surface of the substrate layer, and electrically connecting the flexible circuit board to the conductive material through the wiring.

The embodiment of the present disclosure may have the following beneficial effects: the conductive via hole is disposed on the substrate layer of the display screen, and the conductive material is provided in the conductive via hole, and the conductive material is used as the signal path, which saves the space occupied by the circuitry to pass through from the side of the display screen, reduces the distance between the display screen and the device frame, and increases the screen-to-body ratio of the electronic device.

Understandably, the term “plurality” herein refers to two or more. “And/or” herein describes the correspondence of the corresponding objects, indicating that any of three kinds of relationships may exist. For example, A and/or B, can be expressed as: A exists alone, A and B exist concurrently, B exists alone. The character “/” generally indicates that the context object is an “OR” relationship.

The reference numerals in the present disclosure are merely intended for description and do not represent any merits.

The foregoing descriptions are merely preferred embodiments of the present disclosure, and are not intended to limit the present disclosure. Within the spirit and principles of the disclosure, any modifications, equivalent substitutions, improvements, etc., are within the scope of protection of the present disclosure.

What is claimed is:

1. A display comprising:
a backlight module,
a substrate layer,
a liquid crystal display layer, and
a driving component;
wherein the substrate layer, the liquid crystal display layer, and the driving component are disposed above the backlight module; and
wherein at least one conductive via hole is disposed in the substrate layer, the conductive via hole being provided with a conductive material, and the conductive material providing a signal path for the driving component.

2. The display according to claim 1, wherein the driving component comprises a flexible circuit board and a driving chip, and wherein the signal path comprises at least one of: a path between the driving chip and the flexible circuit board, or a path between the liquid crystal display layer and the flexible circuit board.

3. The display according to claim 2, wherein:
the driving chip is disposed on an upper surface of the substrate layer;
the flexible circuit board is disposed on a lower surface of the substrate layer;
an output pin of the driving chip is connected to an input end of the liquid crystal display layer; and
an input pin of the driving chip is connected to an output end of the flexible circuit board through the conductive material.

4. The display according to claim 2, wherein:
the flexible circuit board is disposed on a lower surface of the substrate layer; an output end of the flexible circuit board is connected to an input end of the liquid crystal display layer through the conductive material; and
an input end of the flexible circuit board is connected to an output pin of the driving chip.

5. The display according to claim 1, wherein the conductive via hole has a diameter of 5 um to 30 um.

6. The display according to claim 2, wherein the conductive via hole has a diameter of 5 um to 30 um.

7. The display according to claim 3, wherein the conductive via hole has a diameter of 5 um to 30 um.

8. The display according to claim 4, wherein the conductive via hole has a diameter of 5 um to 30 um.

9. A terminal comprising: a control unit, a middle frame, and a display disposed at a front side of the middle frame,
wherein the display comprises: a backlight module, a substrate layer, a liquid crystal display layer and a driving component; the substrate layer, the liquid crystal display layer and the driving component being disposed above the backlight module, and
wherein at least one conductive via hole is disposed in the substrate layer, the conductive via hole being provided with a conductive material, and the conductive material forming a signal path for the driving component.

10. The terminal according to claim 9, wherein:
the driving component comprises a flexible circuit board and a driving chip; and
the signal path comprises at least one of: a path between the driving chip and the flexible circuit hoard, or a path between the liquid crystal display layer and the flexible circuit board.

11. The terminal according to claim 9, wherein:
the driving chip is disposed on an upper surface of the substrate layer;
the flexible circuit board is disposed on a lower surface of the substrate layer;
an output pin of the driving chip is connected to an input end of the liquid crystal display layer; and
an input pin of the driving chip is connected to an output end of the flexible circuit board through the conductive material.

12. The terminal according to claim 9, wherein the flexible circuit board is disposed on the lower surface of the substrate layer, the output end of the flexible circuit board is connected to the input end of the liquid crystal display layer through the conductive material, and an input end of the flexible circuit board is connected to the output pin of the driving chip.

13. The terminal according to claim 9, wherein the conductive via hole has a diameter of 5 um to 30 um.

14. The terminal according to claim 10, wherein the conductive via hole has a diameter of 5 um to 30 um.

15. The terminal according to claim 11, wherein the conductive via hole has a diameter of 5 um to 30 um.

16. The terminal according to claim 12, wherein the conductive via hole has a diameter of 5 um to 30 um.

17. A method for manufacturing a display, the method comprising:
determining a calibrated position of a conductive via hole on a substrate layer;
forming the conductive via hole by performing a micro via hole processing procedure on the substrate layer using the calibrated position;
providing a conductive material within the conductive via hole;
leading out the conductive material by means of a wiring;
attaching the driving component to a surface of the substrate layer and electrically connecting a pin of the driving component to the conductive material through the wiring; and
mounting a backlight module onto a lower surface of the substrate layer.

18. The method according to claim 17, wherein the performing the micro via hole processing procedure on the substrate layer comprises:
performing the micro via hole processing procedure on the substrate layer by any of: lasering, ultrasonic drilling, dry etching, or wet etching; to form the conductive via hole,
wherein the conductive via hole has a diameter of 5 um to 30 um.

19. The method according to claim 17, wherein the providing of the conductive material within the conductive via hole comprises:
filling the conductive via hole with silver paste;
or,
depositing a conductive material within the conductive via hole by using a lighting processing procedure.

20. The method according to claim 17, wherein the driving component comprises a driving chip and a flexible circuit board;
the attaching of the driving component to the surface of the substrate layer and electrically connecting the pin of the driving component to the conductive material through the wiring comprises:
attaching the driving chip to an upper surface of the substrate layer, attaching the flexible circuit board to a lower surface of the substrate layer, and electrically connecting the driving chip and the flexible circuit board to the conductive material through the wiring, respectively;
or,
attaching the flexible circuit board to the lower surface of the substrate layer, and electrically connecting the flexible circuit board to the conductive material through the wiring.
